(19) United States
(12) Patent Application Publication
(10) Pub. No.: US 2010/0211607 A1
(43) Pub. Date: Aug. 19, 2010

(54) INFORMATION UPDATING APPARATUS, INFORMATION UPDATING METHOD AND INFORMATION UPDATING PROGRAM

(75) Inventor: Mitsuhiro Naito, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., Aichi-ken (JP)

(21) Appl. No.: 12/733,665

(22) PCT Filed: Dec. 5, 2008
(86) PCT No.: PCT/JP2008/072599

§ 371 Date: Mar. 12, 2010

(30) Foreign Application Priority Data
Dec. 13, 2007 (JP) 2007-322033

(51) Int. Cl. G06F 17/30

(52) U.S. Cl. 707/802; 707/E17.005; 707/E17.018

(57) ABSTRACT

Additional point information indicating additional points to be added to point searching information recorded in a predetermined recording medium is obtained. Display information for displaying information indicating the additional points on a display is extracted from the additional point information. After the display information is extracted, a point addition processing in which the additional point information is converted to be added to the point searching information is conducted.

### TECHNICAL FIELD

The present invention relates to an information updating apparatus, an information updating method and an information updating program updating information accumulated in a navigation apparatus.

### BACKGROUND ART

Conventionally, as a technique for updating map information used in a navigation apparatus, one for delivering difference information to be added to the map information recorded in a recording medium provided in the navigation apparatus to the navigation apparatus from a map information distribution center is known (for instance, refer to Japanese Patent Application Publication No. JP-A-2007-114422).

### DISCLOSURE OF THE INVENTION

### Problem to be Solved by the Invention

In a related art, it takes time from when an update of delivered information is started until when the update is completed, so that even if the update processing is started, it was impossible to use difference information for a long time.

Specifically, in a navigation apparatus, point searching information is included in map information, and the point searching information is recorded in a predetermined recording medium in a format for searching points. On the other hand, additional point information corresponding to a difference when updating the points is described in a format in which information regarding additional points to be added to the map information is enumerated, for the purpose of reducing the capacity at the time of communication.

Accordingly, in order to search points in the navigation apparatus, there is a need to execute a point addition processing in which the additional point information is converted to be recorded in the recording medium in a format of the point searching information. It generally takes time to execute this processing, and in the related art, it was impossible to use information indicating the additional points until the processing is completed.

The present invention has been made in view of the above-described problems, and an object thereof is to enable to use the information indicating the additional points before the point addition processing is completed.

### Means for Solving the Problem

In order to attain the above object, in the present invention, additional point information indicating the additional points to be added to the point searching information is obtained, and display information for displaying information indicating the additional points on a display is extracted from the additional point information. Subsequently, after the display information is extracted, the point addition processing in which the additional point information is converted to be added to the point searching information is executed.

Specifically, since the display information is extracted from the additional point information before the conversion of the additional point information, a state where the additional point information can be used at least for the display is firstly realized, and the point addition processing is also executed in a state capable of using the additional point information for the display. Accordingly, the point addition processing is also completed after sufficient time elapses under the state capable of using the additional point information at least for the display. When the point addition processing is completed, it becomes possible to execute a search for the points including the added additional points. With the structure as described above, it is possible to use the information indicating the additional points before the point addition processing is completed.

Here, an additional point information obtaining unit is only required to obtain the additional point information indicating the additional points to be added to the point searching information recorded in the recording medium, and to obtain difference information indicating the additional points which are not included in the existing point searching information. Various units can be adopted as a unit for obtaining the additional point information, in which the additional point information may be obtained via a radio communication, or the additional point information recorded in a disk recording medium, a semiconductor memory or the like may be obtained.

Further, the point searching information is information specified so that a desired point can be searched based on various sorts of information corresponded to respective points. The point searching information is also described in a dedicated format for searching the desired point by setting a part or all of the information indicating, for instance, a name, a type, a telephone number, an address and the like corresponded to the point as a key. Specifically, in the point searching information, a data structure is built so as to enable a high speed search. For example, when the point is searched based on a certain key, it is structured to limitedly specify targets to be searched when searching an arbitrary key so that not all of the point searching information recorded in the recording medium has to be searched. This data structure can be realized by, for instance, a tree structure which may be built such that when a first letter of the name of the point is specified, the points whose first letter of the names is the specified letter are limitedly specified.

On the other hand, the additional point information is information indicating the additional points. The additional point information is comprised only of enumerated information regarding the additional points to be added in order to handle a small amount of information when obtaining the additional point information via the communication or the recording medium. Specifically, the additional point information has a format different from that of the point searching information. For instance, the additional point information is comprised of all information regarding the additional points which can be referred to by the navigation apparatus, such as positions (for example, coordinates, addresses and the like), identification information (for example, names, types and the like), telephone numbers and the like of the respective additional points.

A display information extracting unit is only required to extract the information for displaying the additional points on the display from the additional point information. Also, the display information extracting unit is only required to extract the information for getting a user to recognize the additional points by at least displaying the additional points on the display and to make a state where the information can be used. For example, if information indicating the position of the additional point and the identification information for identifying the additional point are extracted as the display information and these pieces of information are displayed on the display, it becomes possible that the user determines whether or not the additional point is the desired additional point based on the position and the identification information of the additional point. Note that when extracting the display information and making it usable, it is preferable to make a state where the display information is recorded in a RAM and a control section such as a CPU can directly access the information.

A point information processing unit is only required to perform the point addition processing after the extraction of the display information. Therefore, it is only required at least to extract the display information and make it usable, and thereafter, to realize a state where the point addition processing is executed if it is possible. As a preferable structural example for realizing this, a structure may be adopted in which an additional point display processing for displaying the display information on the display is executed with priority over the point addition processing.

Specifically, if the additional point display processing for displaying the information indicating the additional points on the display based on the display information is conducted, it is possible at least to get the user to recognize the additional points. Accordingly, if the additional point display processing is executed with priority over the point addition processing, a state where the information indicating the additional points on the display is firstly realized by the additional point display processing, which enables the user to recognize that the points are newly added by visually recognizing the display. Therefore, it becomes possible to drive toward the point, and the like. Further, although with a lower priority than the additional point display processing, the point addition processing is also executed. When sufficient time elapses, the point addition processing is also completed, and a search for the points including the added additional points becomes possible.

Here, to execute with priority may refer to a realization of a state where at least the additional point display processing is always capable of being executed and the point addition processing is executed if it is possible. Various structures can be adopted in which, for example, it may be structured such that a resource (a CPU power and a memory amount) or the like is allocated to the additional point display processing with priority over the point addition processing in a parallel processing. Also, it may be structured such that when an instruction to execute the additional point display processing is made, the additional point display processing is executed until it is completed and thereafter the point addition processing is executed.

The additional point display processing is only required to display the information indicating the additional points on the display based on the extracted display information and display styles of the additional points are not particularly limited. Various structures can be adopted, in which, for instance, it may be structured such that the additional points are displayed on the map or list-displayed on the display.

Note that in the structure where the additional points are displayed on the map, the additional point display processing obtains the map information recorded in the predetermined recording medium, displays a map on the display based on the map information and displays the additional points on the map based on the display information. Further, in the structure where the additional points are list-displayed, the additional point display processing obtains information indicating one or a plurality of additional point(s) by referring to the display information in accordance with an instruction in an input device and displays the information indicating the one or the plurality of additional point(s) on the display.

Further, the additional point display processing may be structured to accept a selection of the additional point displayed on the display. Specifically, it is structured such that the information indicating the additional points is displayed on the display based on the display information and the selection of the additional point is accepted. Therefore, it becomes possible to set the additional point as a place of departure, destination, via point or the like of route guidance based on the selection. It is needless to say that selection styles of the additional points are not particularly limited. For instance, it may be structured such that the selection of the additional point displayed on the display is accepted via a predetermined input device.

In the point addition processing, it is only required to convert the additional point information and add it to the point searching information, in which the additional point information formed in a format where the additional points are enumerated is converted into the point searching information formed in a format where the information is specified so that the desired additional point can be searched based on the various pieces of information corresponded to the respective additional points, and the additional points are added to the point searching information. Therefore, it is possible to adopt a structure such that, for example, the pieces of information indicating the name, the type, the telephone number, the address and the like corresponded to the additional points are sequentially extracted from the additional point information and a tree-structured format is formed by corresponding another key related to a certain key to the certain key.

Further, as a preferable structure example in the point addition processing, it is possible to adopt a structure in which the additional point information corresponding to the additional points included in a region previously selected by a user is preferentially converted and added to the point searching information. Specifically, when the additional point information is converted, a priority is set based on the selection of the user, and the additional points included in a region with high priority are preferentially converted into the point searching information.

With this structure, it is possible to shorten a period of time required for making it possible to search the additional points in which the user is highly interested. Note that it is only required that the region with high priority can be selected by the user. It may be structured such that the selection of the region is previously accepted through the predetermined input device and the region is determined based on the selection. Further, a size of the region is not particularly limited. The region may be defined by a mesh being a section of the map information used in the navigation apparatus as a unit, by a name of city, town or village, or by a name of prefecture and the like, and by a specific road (for instance, a toll road or the like) as a unit, and as such, various structures can be adopted. Note that other than the structure to get the user to select the region with high priority, a structure may be adopted in which the point addition processing with respect to regions closer to a home of the user which is previously registered by the user in the navigation apparatus is preferentially conducted.

Further, such as that adopted in the present invention can also be applied as a program or a method, a technique in which the display information for displaying the additional points on the display is extracted from the additional point information and thereafter the point addition processing is executed. Further, the information updating apparatus, the information updating method and the information updating program as described above may be realized as a single information updating apparatus or may be realized by using parts used in common with respective sections provided in a vehicle, and as such, they can be realized by various styles. For example, it is possible to provide an information updating apparatus, an information updating method and an information updating program provided with a part or all of the information updating apparatus as described above. Further, it is possible to appropriately make a change such that one part is realized by software and another part is realized by hardware. Furthermore, the invention is also achieved as a recording medium of a program controlling the information updating apparatus. It is needless to say that the recording medium of the software may be a magnetic recording medium, a magneto-optical recording medium, and even any recording medium to be developed in the future.

### BRIEF DESCRIPTION OF THE DRAWINGS

FIG. 1 is a block diagram of an information updating apparatus;

FIGS. 2A and 2B are views schematically showing data structures of difference information and additional point information;

FIG. 3 is a flow chart of an information update processing;

FIG. 4 is a flow chart of a processing in an information control center;

FIG. 5 is a flow chart of a point information processing; and

FIGS. 6A and 6B are views showing screens in an additional point display processing.

### DESCRIPTION OF THE REFERENCE NUMERALS

10 navigation apparatus
20 control section
21 information update program
21a additional point information obtaining section
21b display information extracting section
21c point information processing section
21c1 additional point display processing part
21c2 point addition processing part
30 recording medium
30a additional point information
30b map information
30b1 point searching information
40 communication section
41 display
42 input device

### BEST MODES FOR CARRYING OUT THE INVENTION

Here, embodiments of the present invention will be explained in an order described below.

(1) Structure of information updating apparatus:

(2) Information update processing:
(2-1) Point information processing:

(3) Other embodiments:

### (1) Structure of Information Updating Apparatus

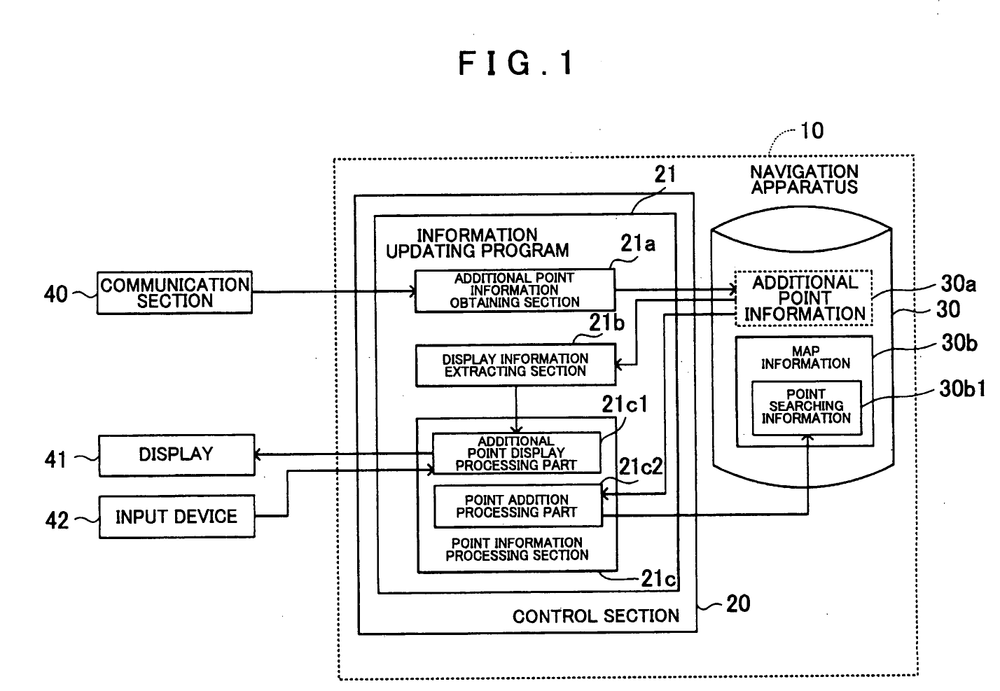

FIG. 1 is a block diagram showing a navigation apparatus including an information updating apparatus according to the present invention. A navigation apparatus 10 is provided with a control section 20 including a CPU, a RAM, a ROM and the like and a recording medium 30, and programs stored in the recording medium 30 or the ROM can be executed in the control section 20. In the present embodiment, a navigation program can be conducted as one of the programs, in which route guidance and the like of a vehicle is performed by outputting various pieces of information using a display or a speaker. Further, the navigation program includes, as one of its functions, an update function of map information, and the update function is realized by an information updating program 21 shown in FIG. 1.

A vehicle (vehicle in which the navigation apparatus 10 is installed) is provided with a communication section 40, a display 41 and an input device 42 to realize the update function of the map information using the information updating program 21. A transmission/reception of signals between these respective sections and the control section 20 is realized by a not-shown interface.

The communication section 40 provided with a radio communication circuit can communicate with a communication section provided in a map information control center controlling map information to thereby transmit/receive information. In the present embodiment, the control section 20 controls the communication section 40 and obtains difference information on the map information transmitted from the map information control center. Note that the map information control center is provided with a recording medium for recording the map information, and in the map information control center, operations for updating the map information and recording it in the recording medium are conducted. The difference information in the present embodiment is new information which is not included in the map information in a later-described recording medium provided in the navigation apparatus 10.

The display 41 being a display capable of displaying an arbitrary image by a control of the control section 20 is used for the aforementioned route guidance, and further, it functions as a UI when displaying points (candidates for the place of departure, destination, via point or the like) for specifying the route and when selecting the points. The input device 42 is a device accepting an instruction from a user through a button, a touch panel or the like, and the control section 20 obtains a signal output from the input device 42 in accordance with the instruction and obtains contents of instruction from the user based on the signal.

The information updating program 21 according to the present embodiment is provided with an additional point information obtaining section 21a, a display information extracting section 21b and a point information processing section 21c to conduct a processing for updating the map information. Further, the recording medium 30 stores map information 30b to conduct guidance by the navigation program, and the map information 30b is referred to for specifying a position of the vehicle.

The map information 30b includes information regarding a map used in the navigation program. For instance, the map information 30b includes road information such as node data indicating nodes set on a road and link data indicating a link of each node, background information indicating a background when displaying the map on the display 41, image information indicating images when displaying the points, the road and the like on the map, voice information indicating a voice when conducting voice guidance, and parameter information indicating a parameter of average speed or the like when predicting arrival time, are included.

Further, in the present embodiment, the map information 30b includes point searching information 30b1 for searching the points. The point searching information 30b1 is information defined for searching points capable of being set in the navigation apparatus 10, and specified so that a desired point can be searched by corresponding various sorts of information (a name, a type, a telephone number, an address and the like) to the respective points. In the present embodiment, the point searching information 30b1 is described in a dedicated format for searching the desired point by setting a part or all of the various sorts of information corresponded to the point as a key.

Specifically, in the point searching information 30b1, a data structure is built so as to enable a high speed search, in which it is structured such that not all of the point searching information 30b1 recorded in the recording medium 30 has to be searched when the point is searched based on a certain key. More specifically, the data structure is formed by a tree structure so that targets to be searched are limitedly specified when searching an arbitrary key. For instance, the tree structure is built such that when a first letter of the name of the point is specified, the points which have the same first letter in the name of the points are limitedly specified.

The additional point information obtaining section 21a is a module obtaining, from the difference information, the additional point information indicating the additional points to be added to the point searching information 30b1, and the control section 20 obtains the additional point information delivered from the map information control center through the processing of the additional point information obtaining section 21a. Specifically, through the processing of the additional point information obtaining section 21a, the control section 20 controls the communication section 40 to communicate with the map information control center, thereby obtaining the difference information. Subsequently, the control section 20 obtains the additional point information from the difference information and records it in the recording medium 30 (the additional point information 30a shown in FIG. 1).

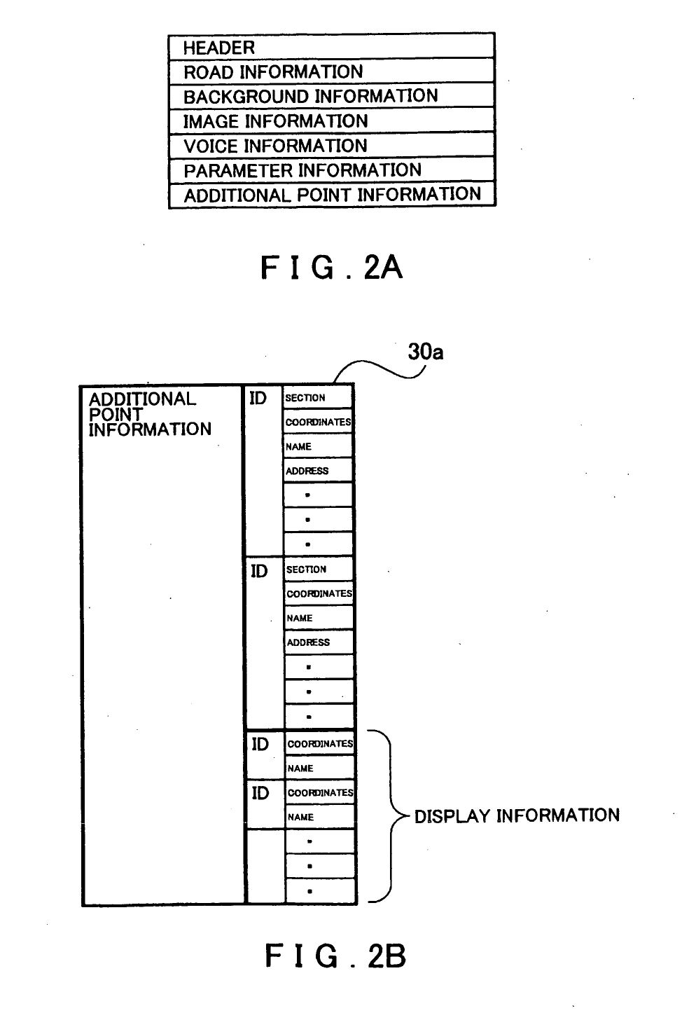

FIGS. 2A and 2B are views schematically showing data structures of the difference information and the additional point information 30a, in which FIG. 2A indicates the difference information and FIG. 2B indicates the additional point information 30a. As shown in FIG. 2A, the difference information includes the aforementioned road information, background information, image information, voice information, parameter information and additional point information 30a after a header, and these pieces of information are new information which are not included in the existing map information 30b.

In the additional point information 30a, the respective additional points subject to addition are specified by IDs, and information indicating a section (mesh), information indicating a position (for instance, coordinates, an address and the like) and identification information (for instance, a name, a type and the like) with respect to the additional point specified by each ID are enumerated, as shown in FIG. 2B. Further, although being omitted in FIG. 2B, other than the aforementioned sorts of information, various sorts of information regarding the additional points (for instance, a telephone number and the like) are enumerated, in which all the information capable of being referred to by the navigation apparatus and regarding the additional points are enumerated.

Note that in the present embodiment, in order to make it possible to easily extract the information used in a later-descried additional point display processing, the display information for displaying the additional points is added to the additional point information 30a. Specifically, the information indicating the positions (coordinates in FIG. 2B) and the identification information (names in FIG. 2B) on the respective additional points included in the additional point information 30a are enumerated as the display information and added to the additional point information 30a. In the present embodiment, the display information is added to the additional point information 30a, but, it is needless to say that it may be structured such that a redundant description in which the display information is added to the additional point information 30a is not performed, and the positions and the identification information of the additional points included in the additional point information 30a are sequentially extracted.

As described above, the additional point information 30a being the information regarding the additional points and the difference information indicating the additional points which are not included in the point searching information 30b1 has a format different from that of the point searching information 30b1. Specifically, the additional point information 30a is the information indicating the additional points and the additional point information 30a is comprised only of enumerated information regarding the additional points to be added in order to handle a small amount of information when obtaining the additional point information 30a via the communication or the recording medium.

Accordingly, the present embodiment is structured to convert the additional point information 30a into the point searching information 30b1 suitable for search, but, it takes time for the conversion. Therefore, in the present embodiment, a state where the search for the additional points cannot be conducted but the display and selection of the additional points on the display 41 can be performed is precedently generated, and thereafter, the point searching information 30b1 is formed from the additional point information 30a. This state is realized by the display information extracting section 21b and the point information processing section 21c.

The display information extracting section 21b is a module for extracting, from the additional point information 30a, the display information for displaying the information indicating the additional points on the display 41. The control section 20 extracts the aforementioned display information from the additional point information 30a recorded in the recording medium 30 through the processing of the display information extracting section 21b.

The point information processing section 21c is provided with an additional point display processing part 21c1 displaying the additional points and accepting the selection of the additional point and a point addition processing part 21c2 adding the points to the point searching information 30b1. Also, the point information processing section 21c is a module for making the control section 20 execute these processings while controlling a priority of the respective processings.

The additional point display processing part 21c1 is a module performing a processing to display the information indicating the additional points on the display 41 based on the aforementioned display information and to accept the selection of the additional point. Specifically, the control section 20 obtains the map information 30b and displays a map including the existing points on the display 41. Further, the control section 20 specifies positions of the additional points included in the map being displayed by referring to the display information and displays the additional points on the map being displayed on the display 41 through the processing of the additional point display processing part 21c1.

Further, through the processing of the additional point display processing part 21c1, the control section 20 obtains the output signal of the input device 42 and specifies the contents of instruction from the user. When the instruction indicates a selection of the additional point, the selection of the additional point is accepted. Therefore, through this processing, it becomes possible to select the additional point included in the additional point information 30a as a place of departure or destination. The point selected here becomes the place of departure, destination, via point or the like, and a route in which the additional point is set as the place of departure, destination, via point or the like is searched and then guided to a driver of a vehicle.

The point addition processing part 21c2 is a module executing a processing in which the additional point information 30a is converted to be added to the point searching information 30b1. Specifically, through the processing of the point addition processing part 21c2, the control section 20 sequentially extracts the pieces of information regarding the additional points from the aforementioned additional point information 30a, analyzes contents of the information, and adds to the tree-structured format in the point searching information 30b1. For instance, when a first letter of a name of a certain additional point is the same as that of names of other points or additional points, the certain additional point is defined to be in the same classification as the other points or additional points, and by performing a classification also with respect to a second letter and letters after that, the tree-structured data is built.

Further, through the processing of the point information processing section 21c, the control section 20 executes the processing of the additional point display processing part 21c1 and the processing the point addition processing part 21c2 described above, in which the processing of the additional point display processing part 21c1 is preferentially executed. In the present embodiment, both the processing of the additional point display processing part 21c1 and the processing the point addition processing part 21c2 are executed in a parallel processing by allocating a resource (a CPU power and a memory amount) or the like to the additional point display processing part 21c1 with priority over the point addition processing part 21c2.

As a result of the above, the state where the information indicating the additional points is displayed on the display 41 and the additional points are selectable is firstly realized by the additional point display processing part 21c1, which enables a user to select a desired additional point while visually recognizing the display 41. Further, although with a lower priority than the processing of the additional point display processing part 21c1, the processing of the point addition processing part 21c2 is also executed in the background. When sufficient time elapses, the processing of the point addition processing part 21c2 is also completed, and when the processing of the point addition processing part 21c2 is completed, a search for the points including the added additional points becomes possible. Therefore, according to the structure descried above, it is possible to use the information indicating the additional points before the processing of the point addition processing part 21c2 is completed.

### (2) Information Update Processing

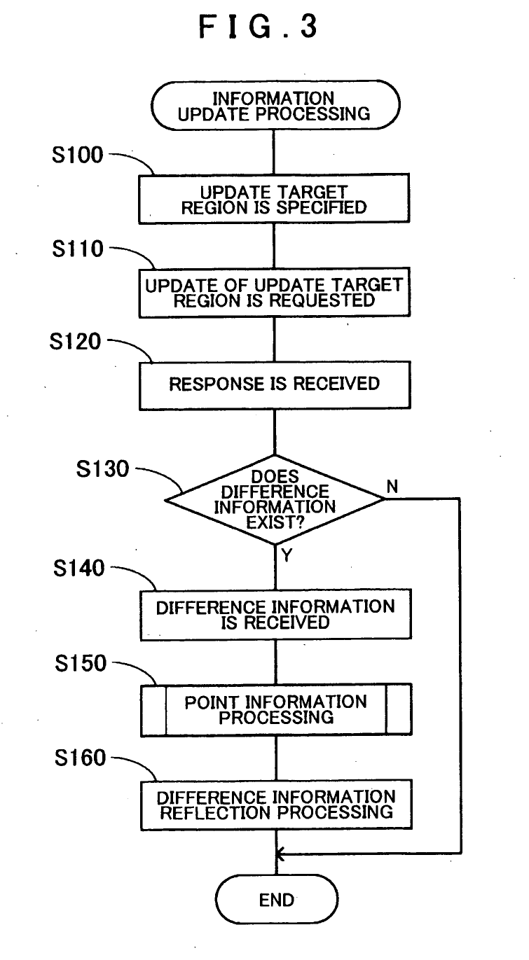

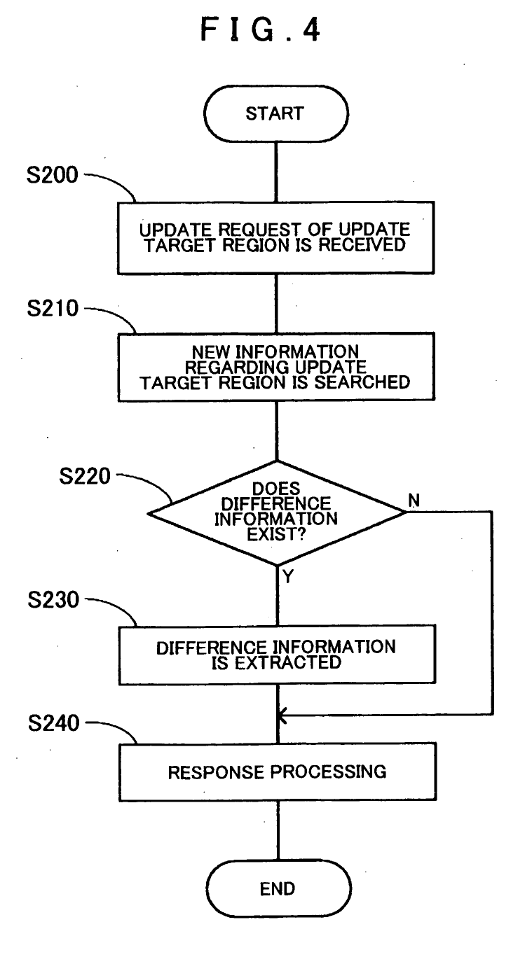

Next, an information update processing conducted by the navigation apparatus 10 in the aforementioned structure will be explained. In the navigation apparatus 10, the control section 20 repeatedly executes the information update processing shown in FIG. 3 at a predetermined timing. Further, in the information control center, a processing shown in FIG. 4 is executed in response to the processing shown in FIG. 3. In the information update processing, the control section 20 specifies an update target region to be a target of the information update through the processing of the additional point information obtaining section 21a (step S100). Specifically, the control section 20 obtains information indicating the update target region based on the information input through the input device 42 or the predetermined set information. Here, the update target region is a region to be a target when updating the map information 30b, and an arbitrary region can be designated in which all areas of the map are set as an upper limit area and the aforementioned section is set as a unit.

Next, the control section 20 requests the information control center to update the update target region through the processing of the additional point information obtaining section 21a (step S110). The information control center receives the update request of the update target region (step S200). Specifically, the control section 20 transmits information for requesting the update of the map information together with information indicating the update target region to the information control center via the communication section 40. In the information control center, a not-shown control section receives the information indicating the update target region and the information for requesting the update of the map information via a not-shown communication section.

When the update request is received in the information control center, new information regarding the update target region is further searched in the information control center (step S210). Specifically, in the information control center, the map information recorded in the recording medium provided in the information control center is referred to, and new information which is not recorded in the map information 30b recorded in the recording medium 30 of the navigation apparatus 10 is searched within the update target region. Note that it is possible to determine whether it is new information or not by comparing the information recorded in the map information 30b with the information accumulated in the information control center, or based on an update date, version information or the like of the map information 30b.

Further, in the information control center, it is determined whether difference information being the aforementioned new information exists or not (step S220), and when the difference information is not determined to exist, step S230 is skipped. When the difference information is determined to exist in the step S220, the difference information is extracted and information described in a format for transmitting it to the navigation apparatus 10 (information shown in FIG. 2A) is formed (step S230).

Subsequently, the information control center responds to the request from the navigation apparatus 10 (step S240). Specifically, when the difference information is determined to exist in the step S220, the information control center transmits the difference information via the communication section. Further, when the difference information is not determined to exist in the step S220, the information control center transmits a response indicating that the difference information does not exist via the communication section.

Meanwhile, in the navigation apparatus 10, the control section 20 receives the response from the information control center (step S120) and determines whether or not the difference information is included in the information transmitted as a response (step S130) through the processing of the additional point information obtaining section 21a. When the difference information is not determined to be included in the step S130, a processing of step S140 and processings thereafter are skipped. When the difference information is determined to be included in the step S130, the control section 20 receives the difference information through the processing of the additional point information obtaining section 21a (step S140). The received difference information is recorded in the recording medium 30 through the processing of the control section 20 (the additional point information 30a in the recorded difference information is explicitly shown in FIG. 1).

In the present embodiment, the control section 20 executes a point information processing being a processing with respect to the additional points through the processings of the display information extracting section 21b and the point information processing section 21c (step S150). When the processing with respect to the additional points is completed, it performs a processing to reflect the difference information so that the remaining information of the difference information can be used in the various application programs in the navigation apparatus 10 (step S160).

### (2-1) Point Information Processing

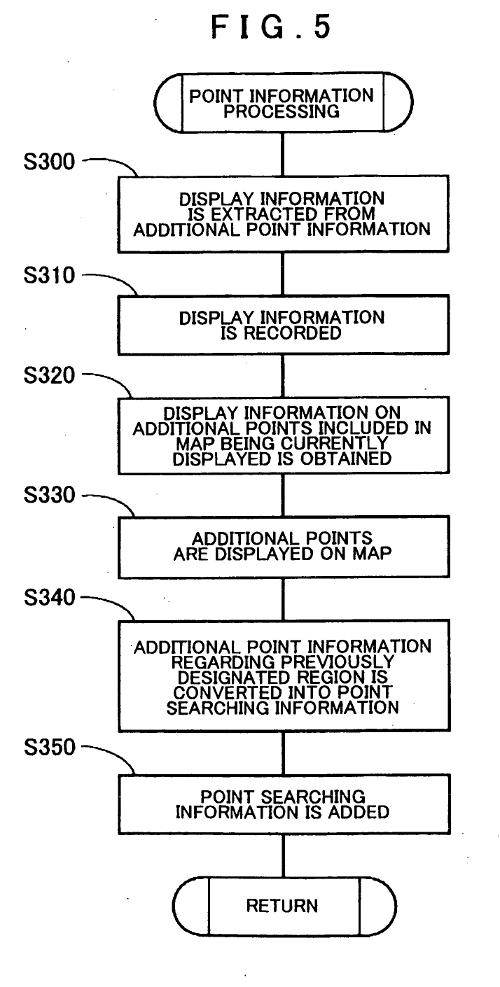

FIG. 5 is a flow chart showing the point information processing in the step S150. The point information processing is composed of an additional point display processing and a point addition processing, and steps S300 through S330 indicate the additional point display processing and steps S340 and S350 indicate the point addition processing.

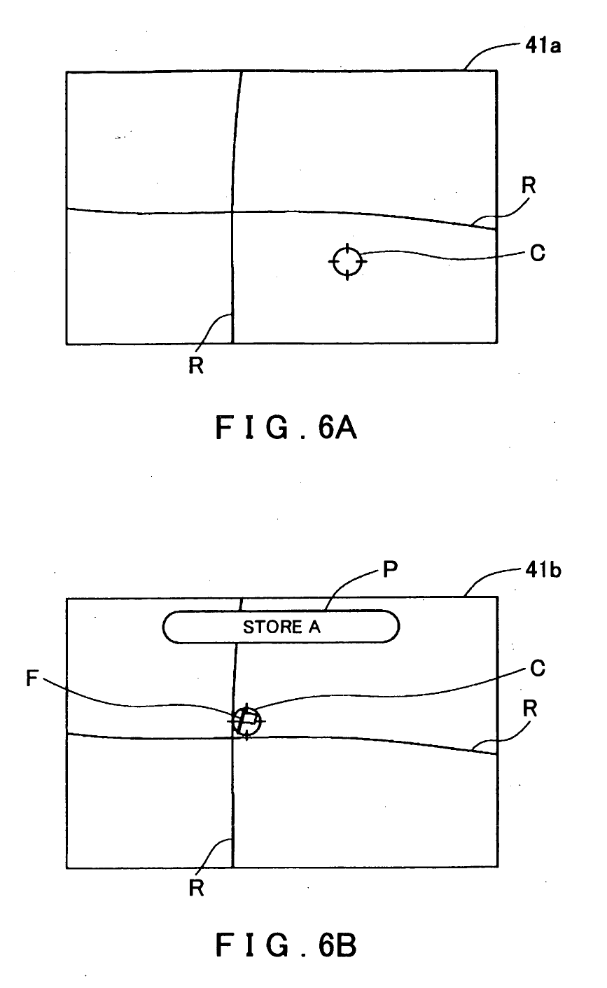

In the additional point display processing, the control section 20 displays a map including a position desired by the user selected by a scroll and the like on the display 41 and accepts the selection of the point based on the output signal of the input device 42. Specifically, the user designates candidates for the point or the additional point displayed on the map through the input device 42, to thereby select the point. FIG. 6A shows a screen 41a to be displayed on the display 41 when the additional point display processing is executed, and in this example, a road R is displayed on the map, and an arbitrary position on the road R can be selected using a selection cursor C.

In order to also make it possible to select the newly added additional point when performing the above-described additional point display processing, the control section 20 first extracts the display information from the additional point information 30a (step S300) and records the display information in the RAM (step S310) through the processing of the display information extracting section 21b. Specifically, the control section 20 refers to the additional point information 30a, extracts the display information (refer to FIG. 2B) included in the additional point information 30a and records it in the RAM being a working area.

Next, the control section 20 obtains the display information regarding the additional points included in the map which is currently displayed through the processing of the display information extracting section 21b (step S320). Specifically, in the additional point display processing, the control section 20 specifies a coordinate range of the map being displayed on the display 41, specifies the additional points included in the coordinate range based on the display information, and obtains the display information. Subsequently, through the processing of the display information extracting section 21b, the control section 20 displays the additional points included in the map being displayed, on the map (step S330).

In the present embodiment, the control section 20 controls the display 41 and displays an image of a not-shown marker (a flag, for instance) previously recorded in the recording medium 30 in a position corresponding to the coordinates of the additional point on the map. FIG. 6B shows a screen 41b in a state where an image of flag F is displayed on the coordinates of the additional point. In this example, it is structured to select the point by overlaying the selection cursor C on the image of flag F, and to display, under the state where the additional point is selected, a name (a store A in an example shown in FIG. 6B) being the identification information on the additional point on a name display position P.

Further, it is structured such that the user selects the additional point corresponding to the image of flag F by giving an instruction with the input device 42 in a state where the selection cursor C is overlaid on the image of flag F. Therefore, the user can select the point, in a structure where he/she selects the desired point while visually recognizing the screen 41b, using the newly added additional point as a candidate for the selection.

Further, the control section 20 executes the point addition processing in parallel with the above-described additional point display processing which is being preferentially executed. Specifically, through the processing of the point addition processing part 21c2, the control section 20 converts the additional point information 30a regarding the previously designated region into the point searching information (step 5340) and adds the converted point searching information to the point searching information 30b1 of the recording medium 30 (step S350).

Specifically, the user previously designates the desired region through the operation of the input device 42, and the control section 20 preferentially converts the additional point information 30a regarding the additional points included in the previously designated region into the point searching information 30b1. As a result of this, the additional points included in the region designated by the user are registered in the point searching information 30b1 with priority over the other additional points. Therefore, a period of time required for creating a state where the additional points in which the user is highly interested can be searched can be shorten compared to that taken for making it possible to search the other additional points. When the point addition processing with respect to the region previously designated by the user is completed, the control section 20 performs a processing in which the additional point information 30a is converted to be added to the point searching information 30b1 also with respect to the other additional points.

Note that a size of the region designated by the user is not particularly limited. The region may be defined by a mesh being a section of the map information used in the navigation apparatus as a unit, by a name of city, town or village, or by a name of prefecture and the like, and by a specific road (for instance, a toll road or the like) as a unit, and as such, various structures can be adopted. It is needless to say that it may be structured such that the point addition processing with respect to regions closer to a home of the user which is previously registered by the user in the navigation apparatus is preferentially executed. When the point addition processing is conducted as described above, with reference back to the flow chart shown in FIG. 3, the control section 20 performs a processing in which the difference information other than the additional point information 30a is referred to and reflected upon the map information in the recording medium 30 (step S160). By the above-described processings, the update processing of the map information is realized.

In the present embodiment, the aforementioned steps 5340 and 5350 are executed with lower priority than the additional point display processing in the steps 5300 through S330 while being executed in parallel therewith. Therefore, the point addition processing is executed also during a period of time in which the user executes the additional point display processing, and if the point addition processing with respect to all the additional points is not completed after the additional point display processing is terminated, the point addition processing is continuously executed.

Further, even if the additional point display processing is once terminated as described above, the additional point display processing is executed with priority over the point addition processing. Therefore, when the user again instructs the execution of the additional point display processing, the selection of the point as illustrated in the aforementioned FIG. 6B can be conducted. Specifically, even if the point addition processing is not completed when the execution of the additional point display processing is instructed and thus the search for the additional points cannot be conducted, it is possible to at least select the added new additional point with a screen as shown in FIG. 6B.

### (3) Other Embodiments

The aforementioned embodiment is one example for carrying out the present invention, and other than that, various structures can be adopted as long as the processing for at least selecting the additional point by extracting the display information for displaying the additional points on the display from the additional point information can be preferentially executed. For instance, a unit for obtaining the additional point information 30a is not limited to the radio communication, and it may be structured to obtain the additional point information recorded in a disk recording medium, a semiconductor memory or the like.

Further, the display information to be extracted from the additional point information 30a is only required to be information for at least displaying the additional points on the display to thereby get a user to recognize the additional points. For instance, addresses of the additional points may be obtained as information indicating the positions of the additional points. Types of the additional points may be obtained as identification information for identifying the additional points, and as such, various structures can be adopted. It is needless to say that the display 41 is only required to display the additional points, and as the display 41, a screen provided to an instrument panel and the like other than a screen used in a car navigation may be applied.

Further, the additional point display processing is only required to be executed with priority over the point addition processing, and it is only required to realize a state where at least the additional point display processing is always capable of being executed and the point addition processing is executed if it is possible. Therefore, it is possible to structure such that when an instruction to execute the additional point display processing in addition to the aforementioned parallel processing is made, the additional point display processing is executed until it is completed and thereafter the point addition processing is executed, and as such, various structures can be adopted.

Further, display styles and selection styles of the additional points are not particularly limited in the additional point display processing, and it may be structured such that the additional points are displayed on the map as described above or the additional points are list-displayed and the selection of the additional point is accepted based on the instruction through the input device. Note that in the structure where the additional points are list-displayed, information indicating one or a plurality of additional point(s) is obtained by referring to the display information and the information indicating the one or the plurality of additional point(s) is displayed on the display in the additional point display processing. Further, the selection of the additional point is accepted in the input device 42 through the input designating either of the one or the plurality of additional point(s). Subsequently, the selected additional point is set as a place of departure, destination, via point or the like of route guidance.

Further, in the aforementioned embodiment, it is structured to display the additional points and to accept the selection of the additional point with the additional point display processing part 21c1, but, it may be structured not to accept the selection of the additional point. Specifically, if it is structured such that the display information is extracted from the additional point information 30a and displayed on the display 41, it becomes possible that the user who visually recognizes the display drives toward the additional point and the information indicating the additional points can be used before the completion of the point addition processing.

Further, the display information is only required to be in a state where it can be used by being extracted before the processing of the point addition processing part 21c2 is started. Specifically, the display information is at least extracted in the display information extracting section 21b before the additional point information 30a is converted and the additional points are added to the point searching information 30b. Subsequently, it is just required to create a state where the display based on the display information can be conducted in accordance with the instruction in the input device 42. Further, the structure to execute the additional point display processing with priority over the point addition processing may be a structure where the additional point display processing starts to be executed before the point addition processing, or a structure where both the processings can be executed at any time in accordance with the instruction in the input device and when they are executed, the additional point display processing is executed with priority over the point addition processing.

1. An information updating apparatus, comprising:
an additional point information obtaining unit obtaining additional point information indicating additional points to be added to point searching information recorded in a predetermined recording medium;
a display information extracting unit extracting display information for displaying information indicating the additional points on a display from the additional point information; and
a point information processing unit executing, after the display information is extracted, a point addition processing in which the additional point information is converted to be added to the point searching information.

2. The information updating apparatus according to claim 1, wherein
the point information processing unit executes an additional point display processing for displaying the information indicating the additional points on the display based on the extracted display information with priority over the point addition processing.

3. The information updating apparatus according to claim 2, wherein
the point information processing unit accepts a selection of the additional point displayed on the display in the additional point display processing.

4. The information updating apparatus according to claim 2 wherein
the point information processing unit obtains map information recorded in a predetermined recording medium to display a map on the display based on the map information and displays the additional points on the map based on the display information in the additional point display processing.

5. The information updating apparatus according to claim 2 wherein
the point information processing unit displays, in the additional point display processing, a list of the information indicating the additional points on the display in accordance with an instruction in an input device.

6. The information updating apparatus according to claim 2, wherein
the display information includes information indicating positions of the additional points and identification information for identifying the additional points.

7. The information updating apparatus according to claim 1, wherein
the point information processing unit preferentially converts the additional point information corresponding to additional points included in a region previously selected by a user and adds the converted additional point information to the point searching information in the point addition processing.

8. An information updating method, comprising the steps of:
obtaining additional point information indicating additional points to be added to point searching information recorded in a predetermined recording medium;
extracting display information for displaying information indicating the additional points on a display from the additional point information; and
conducting, after the display information is extracted, a point addition processing in which the additional point information is converted to be added to the point searching information.

9. An information updating program causing a computer to realize the functions of:
obtaining additional point information indicating additional points to be added to point searching information recorded in a predetermined recording medium;
extracting display information for displaying information indicating the additional points on a display from the additional point information; and
conducting, after the display information is extracted, a point addition processing in which the additional point information is converted to be added to the point searching information.
